(19) United States
(12) Patent Application Publication
(10) Pub. No.: US 2007/0071112 A1
(43) Pub. Date: Mar. 29, 2007

(54) Active EMI suppression circuit

(76) Inventors: Amit Gattani, Roseville, CA (US); Philip John Crawley, Folsom, CA (US); John R. Camagna, El Dorado Hills, CA (US)

Correspondence Address: KOESTNER BERTANI LLP, 18662 MACARTHUR BLVD, SUITE 400, IRVINE, CA, 92612, US

(21) Appl. No.: 11/435,672

(22) Filed: May 16, 2006

Related U.S. Application Data
(63) Continuation-in-part of application No. 11/207,595, filed on Aug. 19, 2005.
(63) Continuation-in-part of application No. 11/207,602, filed on Aug. 19, 2005.
(63) Continuation-in-part of application No. 11/327,128, filed on Jan. 6, 2006.

(51) Int. Cl. H04L 25/00; H04J 3/10

(52) U.S. Cl. 375/257; 370/201

(57) ABSTRACT

In a network device, an active Electro-Magnetic Interference (EMI) suppression circuit is coupled in parallel to transmit and receive differential signal lines connecting an Ethernet physical layer (PHY) module and a network connector, actively suppressing EMI in a network communications system that replaces a traditional transformer with an active direct connect interface.

### CROSS REFERENCE TO RELATED APPLICATIONS

This application claims the benefit of priority to and incorporates herein by reference in its entirety for all purposes, U.S. Provisional Patent Application No. 60/665,766 entitled “SYSTEMS AND METHODS OPERABLE TO ALLOW LOOP POWERING OF NETWORKED DEVICES,” by John R. Camagna, et al. filed on Mar. 28, 2005. This application is related to and incorporates herein by reference in its entirety for all purposes, U.S. patent application Ser. No.: 11/207,595 entitled “METHOD FOR HIGH VOLTAGE POWER FEED ON DIFFERENTIAL CABLE PAIRS,” by John R. Camagna, et al. filed Aug. 19, 2005; U.S. patent application Ser No.: 11/207,602 entitled “A METHOD FOR DYNAMIC INSERTION LOSS CONTROL FOR 10/100/1000 MHZ ETHERNET SIGNALLING,” by John R. Camagna, et al., filed on Aug. 19, 2005; and U.S. patent application Ser. No.: 11/327,128 entitled “COMMON-MODE SUPPRESSION CIRCUIT FOR EMISSION REDUCTION, ” by Philip John Crawley, et al., filed on Jan. 6, 2006.

### BACKGROUND

Many networks such as local and wide area networks (LAN/WAN) structures are used to carry and distribute data communication signals between devices. Various network elements include hubs, switches, routers, and bridges, peripheral devices, such as, but not limited to, printers, data servers, desktop personal computers (PCs), portable PCs and personal data assistants (PDAs) equipped with network interface cards. Devices that connect to the network structure use power to enable operation. Power of the devices may be supplied by either an internal or an external power supply such as batteries or an AC power via a connection to an electrical outlet.

Some network solutions can distribute power over the network in combination with data communications. Power distribution over a network consolidates power and data communications over a single network connection to reduce installation costs, ensures power to network elements in the event of a traditional power failure, and enables reduction in the number of power cables, AC to DC adapters, and/or AC power supplies which may create fire and physical hazards. Additionally, power distributed over a network such as an Ethernet network may function as an uninterruptible power supply (UPS) to components or devices that normally would be powered using a dedicated UPS.

Additionally, network appliances, for example voice-over-Internet-Protocol (VOIP) telephones and other devices, are increasingly deployed and consume power. When compared to traditional counterparts, network appliances use an additional power feed. One drawback of VOIP telephony is that in the event of a power failure the ability to contact emergency services via an independently powered telephone is removed. The ability to distribute power to network appliances or circuits enable network appliances such as a VOIP telephone to operate in a fashion similar to ordinary analog telephone networks currently in use.

Distribution of power over Ethernet (PoE) network connections is in part governed by the Institute of Electrical and Electronics Engineers (IEEE) Standard 802.3 and other relevant standards, standards that are incorporated herein by reference. However, power distribution schemes within a network environment typically employ cumbersome, real estate intensive, magnetic transformers. Additionally, power over Ethernet (PoE) specifications under the IEEE 802.3 standard are stringent and often limit allowable power.

Many limitations are associated with use of magnetic transformers. Transformer core saturation can limit current that can be sent to a power device, possibly further limiting communication channel performance. Cost and board space associated with the transformer comprise approximately 10 percent of printed circuit board (PCB) space within a modern switch. Additionally, failures associated with transformers often account for a significant number of field returns. Magnetic fields associated with the transformers can result in lower electromagnetic interference (EMI) performance.

However, magnetic transformers also perform several important functions such as supplying DC isolation and signal transfer in network systems. Thus, an improved approach to distributing power in a network environment may be sought that addresses limitations imposed by magnetic transformers while maintaining transformer benefits.

### SUMMARY

According to an embodiment of a network device, an active Electro-Magnetic Interference (EMI) suppression circuit is coupled in parallel to transmit and receive differential signal lines connecting an Ethernet physical layer (PHY) module and a network connector, actively suppressing EMI in a network communications system that replaces a traditional transformer with an active direct connect interface.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams that respectively illustrate a high level example embodiments of client devices in which power is supplied separately to network attached client devices, and a switch that is a power supply equipment (PSE)-capable power-over Ethernet (PoE) enabled LAN switch that supplies both data and power signals to the client devices;

FIG. 2 is a functional block diagram illustrating a network interface including a network powered device (PD) interface and a network power supply equipment (PSE) interface, each implementing a non-magnetic transformer and choke circuitry;

FIG. 3 is a schematic block and circuit diagram showing an embodiment of a network device that includes a common mode suppression circuit;

FIG. 4 is a schematic block and circuit diagram showing an embodiment of a traditional choke that may be used in conjunction with an Ethernet physical layer (PHY);

FIG. 5 is a schematic circuit and block diagram depicting an example of system noise coupling paths for emissions that may arise in a network device;

FIG. 6 is a schematic circuit diagram illustrating a common mode suppression circuit with additional detail of the circuit and further description of the signal path; and

FIG. 7 is a schematic block and circuit diagram showing an embodiment of a programmable output stage.

### DETAILED DESCRIPTION

In an illustrative architecture of a common-mode suppression circuit, a common-mode suppression amplifier is coupled to output lines of an Ethernet physical layer (PHY). An active common mode suppression circuit is coupled in parallel to transmit and receive differential signal lines connecting an Ethernet physical layer (PHY) module and a network connector. In a transformer-less configuration, the circuit can replace electromagnetic interference (EMI) suppression chokes that are included in modern Ethernet transformers.

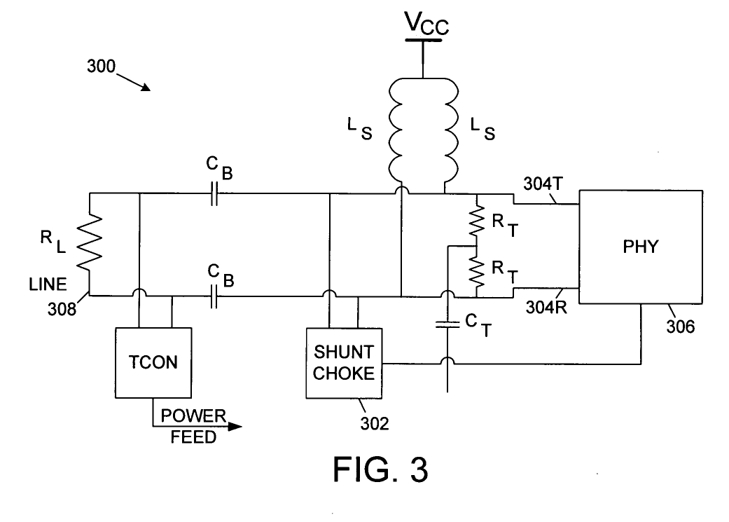

Referring to FIG. 3, a schematic block and circuit diagram illustrates an embodiment of a network device 300 including a common mode suppression circuit 302. The common mode suppression circuit 302 is an active device that is coupled in parallel to transmit and receive differential signal lines 304T, 304R connecting an Ethernet physical layer (PHY) module 306 and a network connector 308.

The common mode suppression circuit 302 may be described functionally as a shunt choke or choke. The common mode suppression circuit (CMS) 302 is connected in parallel to the same wires 304T, 304R as the Ethernet PHY 306 whereby the shunt choke terminology is descriptive of the parallel connection. The common mode suppression circuit 302 operates as a functional block, coupled in parallel to the signal lines 304T, 304R, that supplies a very low common mode impedance termination. Accordingly, substantially all common mode noise in the system is absorbed by the common mode suppression circuit 302.

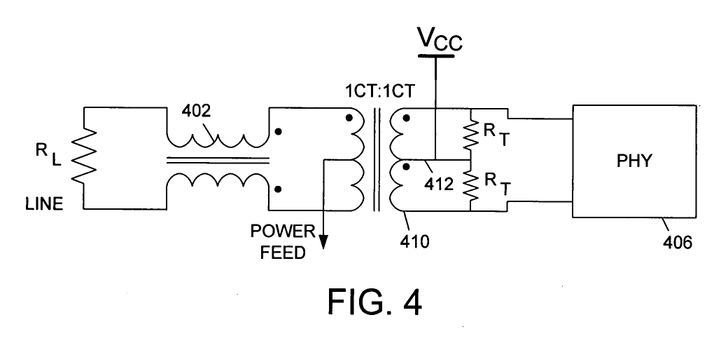

The common mode suppression circuit 302 performs aspects of a traditional choke 402 that may be used in conjunction with an Ethernet PHY 406 as shown in FIG. 4. The Ethernet PHY 406 has signal lines coupled to a traditional transformer 410. The choke 402 is depicted as horizontal windings coupled to the transformer 410. The common mode suppression circuit 302 depicted in FIG. 3 performs aspects of the choke functionality in active circuitry. The common mode suppression circuit 302 is configured to interface to standard Ethernet PHY blocks that are traditionally used with transformer-based network devices. Standard Ethernet PHY blocks have Class-A drivers that use the transformer center-tap 412 for direct current (DC) biasing. Accordingly, the standard Ethernet PHY, and not the active choke shunt as may be otherwise be desired, has control of common mode DC voltage at signal lines 304T and 304R.

An Ethernet physical layer (PHY) generally has a Class A driver, specifically a driver that operates in a Class A mode whereby differential mode current varies to define a signal while common-mode current component is maintained constant. The Class A driver conventionally uses a transformer center-tap for direct current (DC) biasing. In a typical implementation output common mode DC voltage of the PHY can vary in a range up to the supply voltage Vcc, for example Vcc can be 3.3V, 2.5V, 1.8V, or any voltage desired by the Ethernet PHY manufacturer. The PHY output voltage swing Vout_swing, which is derived from the common mode DC voltage, can also vary greatly, for example from 0.85V to 5.0V depending on supplied power and Ethernet type, for example 10baseT or Fast Ethernet (100baseT), or Gigabit Ethernet (1000baseT).

A system with a Class A-B capability typically imposes a power supply voltage specification of more than 5V if the output common mode DC voltage is allowed to a 3.3V level. For example, in an implementation of a network device that does not include a Class A output stage on the choke but rather has a more traditional Class A-B output stage, a sufficient and appropriate power supply for the CMS block is greater than 5V because the output swing alone extends from 0.85V to 5.0V, Furthermore, additional headroom above the output swing is also needed in the Class AB type design Class AB and Class B designs operate off both the ground rail and the power supply or Vcc rail. In contrast, the Class A design is only attached to the ground rail. In the Class A design, no connection couples Vcc to the Class A output stage and large voltage swings are more easily tolerated.

Referring again to FIG. 3, an example of typical constraints imposed by usage of the Ethernet PHY 306 include an external load at high frequency is limited by R_{T}, for example 50Ω, Ethernet common mode termination plus parasitic capacitance at the node. The R_{T} Ethernet common mode termination, depicted as R_{T} resistors at input lines to the Ethernet PHY 306, in combination with parasitic capacitors that typically exist in the system add on the order of 20 pF of shunt loading. In a specific design example, common mode rejection ratio may be specified to a frequency of 100 MHz. Consequently, a suitable common mode noise suppression circuit may be specified to include a reasonably high loop gain at 100 MHz. The specification is addressed by implementing a reasonably high loop gain in the specified frequency range. The common mode noise suppression circuit design includes a fundamental trade-off between loop stability and common mode rejection ratio (CMRR) performance. Accordingly, the shunt choke 302 is configured to have suitable high frequency performance to address the loading due to the common mode resistance and parasitic capacitance. In the illustrative example, the loading by a resistance of R_{T}, for example 50Ω, and parasitic capacitance of 20 pF results in a frequency behavior including a pole at 160 MHz in combination with a performance specification imposed on the choke of suitable performance up to 100 MHz. Thus, in the illustrative example, the design challenge is to configure the common mode suppression circuit 302 to have very good rejection at 100 MHz when limited by a 160 MHz pole.

With regard to stability, an analog closed loop can have stable and nonstable operating zones. For example in a configuration with a pole at 160 MHz, good common mode rejection performance imposes specification of a high gain at 100 MHz, contrary to a specification to attain loop stability. In an illustrative design, stability criteria may be addressed by enabling the output stage to roll-off while the input stage maintains high gain.

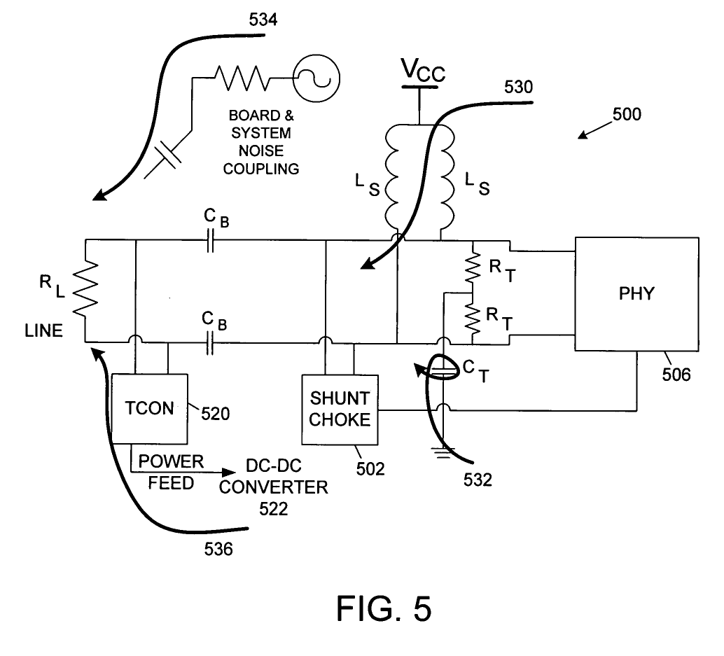

Referring to FIG. 5, a schematic circuit and block diagram illustrates an example of system noise coupling paths for emissions that may arise in a network device 500. The network device 500 comprises an active common mode suppression circuit 502 that is configured to absorb common mode noise by forming a low impedance path from an Ethernet Physical layer (PHY) module 506 output to ground. The Ethernet PHY module 506 has a Class A driver where output common mode level of the Ethernet PHY module 506 can vary up to V_{CC}.

Overall choke functionality addresses highly resonant circuits in all directions including a T connect circuit 520 with blocking capacitors C_{B}, supply inductors L_{S}, and other sources. In an illustrative example, blocking capacitors C_{B} may be selected with a suitable capacitance, for example 68 nF, and supply inductors L_{S}, in an example configuration selected with inductance L_{S}, for example 220 uH. The output load condition is highly variable. Thus, the choke 502 is configured for suitable performance in the megahertz to gigahertz range. Pin wires, supply inductors, and parasitic capacitances all may form noise coupling paths to be addressed by the shunt choke 502.

Arrows are superimposed on FIG. 5 showing possible sources of common mode noise. Noise can possibly propagate from the Vcc power supply path 530, from the Ethernet PHY 506, from the ground path 532, and board and system noise coupling 534 which is capacitive coupling to the line. The board and system noise coupling 534 is an indirect coupling. Noise coupling paths also may include a path 536 through a DC-DC converter 522 through the Tconnect block 520. The function of the choke 502 is to operate as a noise absorber that chokes common mode noise and prevents transmission of common mode noise to the Ethernet twisted pair cable that in turn becomes electromagnetic interference (EMI) emission. The shunt choke 502 absorbs the common mode noise by forming a very low impedance path from the Ethernet PHY output terminals to ground so that any common mode noise follows a path of least resistance through the choke 502 to ground, thereby diverting the noise from the signal line. Supply Vcc is typically a dominant source of noise, although the noise sourced in relatively variable.

The shunt choke 502 can be designed by taking into consideration what noise sources are present, locations of the noise paths, and characteristics, source impedances and worst case conditions of the noise sources.

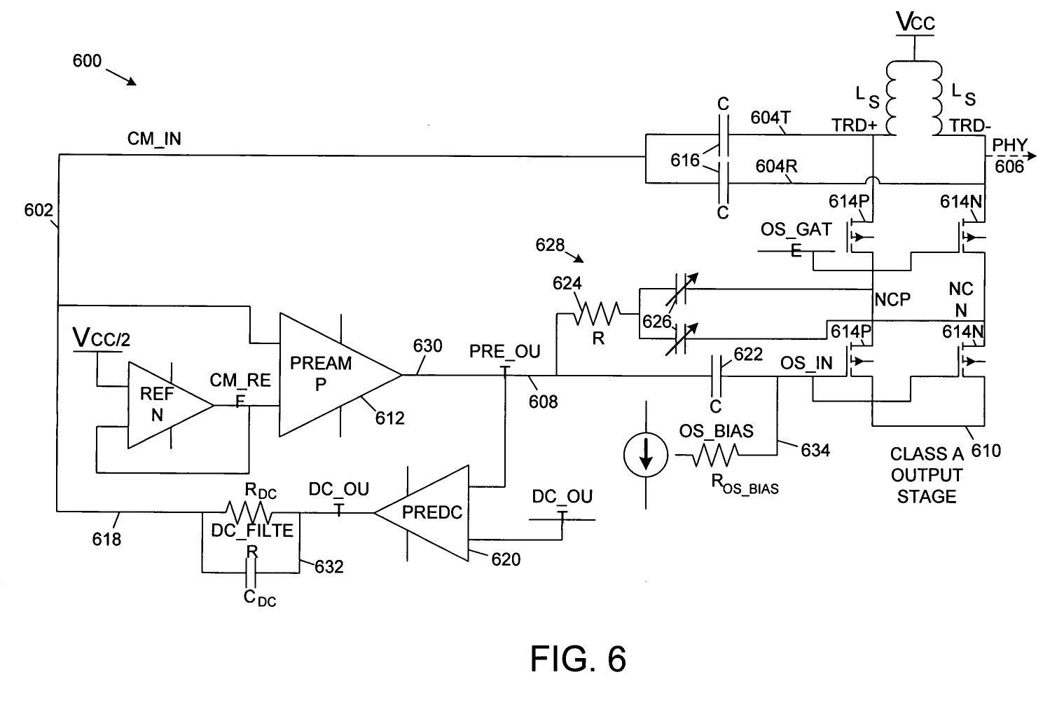

Referring to FIG. 6, in an illustrative embodiment a communication device 600 may be specified to include a Class A driver that operates a common mode suppression circuit coupled to Vcc and ground lines supplying the Ethernet physical layer (PHY). The communication device is a network device 600 comprising an interface 602 coupled in parallel to transmit and receive differential signal lines 604T, 604R connecting an Ethernet physical layer (PHY) module 606 and a network connector operative at a voltage substantially higher than the PHY module 606. The interface 602 comprises a two-stage amplifier gain loop 608 whereby common mode noise is suppressed, in an example embodiment by at least 40 dB in a frequency range from 100 kHz to 30 MHz. The two-stage amplifier gain loop 608 comprises a Class A output stage 610 coupled between the Ethernet PHY and a first stage preamplifier 612 that is capacitively-coupled at input and output terminals.

FIG. 6 illustrates a circuit diagram of the common mode suppression circuit 602 with additional detail of the circuit and further description of the signal path. Transmit and receive signal lines TRD+ and TRD− are coupled to output terminals of an Ethernet PHY integrated circuit chip. Transistors 614P, 614N in the Class A output stage 610 include NMOS transistors 614N coupled between ground and the TRD pins. In the illustrative common mode suppression circuit 602, no active devices are coupled between the power source Vcc and the output lines. The Class A design is a one-sided, open-drain configuration. The illustrative common mode suppression circuit 602 includes capacitors that operate as common mode sampling capacitors 616. Signal cm₁₃ in is a common mode signal is input to the preamplifier 612. The preamplifier 612 drives the output stage 610. The loop 608 is closed by the capacitors 616. Preamplifier 612 is also coupled into a low frequency bias loop or direct current (DC) control loop 618 which includes a preamplifier DC (PREDC) amplifier 620 that functions as a reference amplifier and sets the reference DC voltage. Preamplifier 612 passes an output signal to a preamplifier output node (PRE_OUT) which is separated from an output stage input node (OS_IN) by a signal path capacitor 622 on a capacitively-coupled signal path. A resistor 624 and variable capacitors 626 form a compensation network 628 and passes to a node ncp, ncn between transistors 614P, 614N.

The illustrative network device 600 thus comprises an interface 602 coupled in parallel to transmit and receive differential signal lines 604T, 604R connecting an Ethernet physical layer (PHY) module 606 and a network connector operative at a voltage substantially higher than the PHY module 606. The interface 602 comprises a two-stage amplifier gain loop 608, a preamplifier loop 630 coupled to the two-stage amplifier gain loop 608, a low frequency bias loop 618 coupled to the preamplifier loop 630, a DC filter 632 coupled to the low frequency bias loop 618, and common mode sampling capacitors 616 coupled from an input terminal to the preamplifier loop 630 to transmit and receive data (TRD+/−) lines to the Ethernet PHY 606. The DC filter 632 and the common mode sampling capacitors 616 are configured to set low frequency bias bandwidth.

The shunt architecture 602 is not in a series path of the transmit/receive differential signals but rather is in a parallel path with the signals. The parallel or shunt structure facilitates noise elimination. The communication signal includes two component signal types, a common mode signal and a differential signal. The differential signal is the desired, information-carrying signal that is sought to be communicated on the signal line. The common mode signal is the noise signal is desired to be prevented from passing down the line. The series connection is susceptible to the risk that both the common mode and the differential signals are processed, resulting in possible distortion of the desired differential component. In contrast, the parallel shunt configuration avoids processing of the differential mode signal, improving differential distortion performance at lower cost.

The active common mode suppression circuit 602 is configured to terminate common mode impedance over the Ethernet signal frequency range, for example typically in a range from about 100 kHz to 100 MHz range.

In some embodiments, the active common mode suppression circuit 602 can be configured to terminate common mode impedance over an Ethernet signal frequency range whereby common mode noise is suppressed by at least 40 dB from 100 kHz to 30 MHz. The active common mode suppression circuit 602 forms a loop that creates a second-order roll-off in common mode noise suppression at frequencies above 10 kHz.

In some embodiments, the active common mode suppression circuit 602 is configured in a Class A architecture that matches Ethernet PHY line drivers whereby the Ethernet PHY controls output line signal common mode direct current (DC) voltage. The Class A architecture enables complete control on the output (line signal TRD+/−) common mode DC voltage by the Ethernet PHY 606.

The active common mode suppression circuit 602 and the Ethernet PHY 606 may be manufactured using the same fabrication process and voltage. Accordingly, the common mode noise suppression circuit 602 may be fabricated in the same low voltage process as the Ethernet PHY 606. In contrast, a Class AB type of design may impose a 5 volt fabrication process of more than 5V in contrast to typical 3.3V technologies. The illustrative configurations may be suitable for any current or future fabrication processes, voltages, and technologies.

The two-stage amplifier gain loop 608 enables high common mode suppression performance. For example in some particular configurations, the active common mode suppression circuit 602 may comprise a two-stage amplifier gain loop 608 whereby common mode noise is suppressed by at least 40 dB, for example from 100 kHz to 30 MHz.

An example implementation of the common mode suppression circuit 602 may be configured so that at zero decibels (dB) on the magnitude axis, nothing is rejected or suppressed. A small amount of peaking at about 3 dB occurs at a frequency of about 5 kHz that is essentially immaterial to functionality. A sharp second order roll-off may begin at about 10 kHz and at approximately 100 kHz, the signal may be reduced substantially by approximately −40 dB or more so that at 100 kHz the common mode noise is rejected by 48 dB by the illustrative common mode suppression circuit 602. From 100 kHz to about 10 MHz, the signal may remain below −40 dB then begins to rise and at about 100 MHz. Various standards of performance may be desired but in one embodiment, suppression is most intended for a range from 100 kHz to 100 MHz. Typically, the greatest conductive electromagnetic interference (EMI) difficulty arises in the 100 kHz to 30 MHz range, the range for which performance is optimized in the illustrative common mode suppression circuit 602. The illustrative common mode suppression circuit 602 exceeds a rejection specification of 40 dB in the selected range. In summary, a particular implementation may reject from 0 to 40 dB in a band between 10 kHz to 100 kHz, have rejection greater than 40 dB in a band from 100 kHz to 30 MHz, and have over 30 dB rejection from 30 MHz to 100 MHz.

In some embodiments, the active common mode suppression circuit 602 comprises a Class A output stage 610 coupled between the Ethernet PHY 606 and a first stage preamplifier 612. The first stage preamplifier 612 and the Class A output stage 610 form a two-stage amplifier gain loop 608. The first stage preamplifier 612 is completely AC-coupled to the system at both input (CM_IN) and output (PRE_OUT) terminals. The preamplifier 612 is capacitively-coupled to the TRD loop and is capacitively-coupled to the output stage 610 because neither the range of magnitude of the output common mode nor the voltage level at the TRD node is known. Therefore the two-stage gain loop 608 is enabled to float. On the output side of the loop 608, the common mode suppression circuit 602 supplies both a bias control which is a separate low frequency bias (DC) control signal, and an alternating current (AC) signal. The AC signal is capacitively-coupled on a separate path, depicted as an output stage bias (OS_BIAS) path, which sets DC biasing for the output stage 610. The preamplifier 612 floats and is capacitively-coupled with respect to the TRD+ and TRD− signal lines. The preamplifier 612 has a dedicated low frequency bias or DC control loop 618 for both input and output signals.

The illustrative preamplifier loop 630 is designed so that both the AC signal and DC bias are controlled at the same node CM_IN, the node at which the DC amplifier 620 loops back to the input terminals of the preamplifier 612.

In some embodiments, the network device 600 may be configured with the active common mode suppression circuit 602 comprising a two-stage amplifier gain loop 608, a preamplifier loop 630, a low frequency bias loop 618, a DC filter 632, and common mode sampling capacitors 616 coupled from an input terminal (CM_IN) to the preamplifier loop 630 to transmit and receive data (TRD+/−) lines to the Ethernet PHY 606. The DC filter 632 and the common mode sampling capacitors 616 can be configured to set low frequency bias loop bandwidth. A low frequency bias or DC control loop amplifier 620 for the preamplifier 612 may be designed so that a very low DC loop bandwidth is set by the DC filter 632 by selection of resistor R_{DC} and capacitor C_{DC} and common mode sampling capacitors 616 on the node Cm_in. Accordingly, the two-stage amplifier gain loop 608 progresses from control by the DC amplifier 620 to the AC portion of the circuit at the output stage 610 at increasing frequency with a transition at about 10 kHz between the low frequency bias by the DC loop 618 and high frequency bias at the output stage 610. Essentially no common mode rejection is present below about 10 kHz because the low frequency bias of the DC loop 618 takes over at lower frequencies. Thus, the active common mode suppression circuit 602 is configured to transition from direct current (DC) control to alternating current (AC) control at a sufficiently low frequency that AC performance begins at approximately 10 kHz, attaining excellent AC performance beginning at 10 kHz.

The DC filter 632 may be configured to create resonance in the common mode suppression transfer function in a range approximately between 100 kHz and 30 MHz, enabling very high common mode noise suppression by at least approximately 40 dB and substantially reducing conductive emissions in a band approximately between 100 kHz and 30 MHz. The DC filter 632 is a resistor-capacitor circuit in the DC loop 618 coupled to the output terminal of the PREDC amplifier 620. The R_{DC}C_{DC} circuit that forms the DC filter 632 in combination with common mode sampling capacitors 616 comprise a complete AC impedance at node CM_IN. The DC filter 632 and capacitors 616 set resonance to create the very sharp roll-off in the frequency response to attain common mode rejection of 40 dB to 60 dB in the bandwidth of interest, 100 kHz-30 MHz.

Low frequency bias or DC control bias at multiple nodes including CM_IN node at the input terminal to the preamplifier loop 630, PRE_OUT node at the output terminal of the preamplifier 612, and OS_IN node at the input terminal to the output stage 610 can all be set independently. Independent setting of DC bias at the multiple nodes enables independent system optimization at each of the nodes to any desired DC level because the nodes are AC decoupled. OS_IN node is the bias node for the output stage Class A amplifier output terminal and the DC level set in the OS_IN bias path is controlled independently of any other node. At the PRE_OUT node at the output of the preamplifier 612, the DC level is controlled by the DC_REF path on the PREDC amplifier 620 and can be set for maximum performance of the preamplifier 612. The nodes are decoupled because bias for maximum performance of the preamplifier 612 may not match bias for maximum performance of the output stage 610. Input bias of the preamplifier 612 is set by the Cm_ref node to enable optimization to any bias that produces maximum performance without dependence on the other nodes.

In some embodiments, an output stage bias loop 634 coupled between the preamplifier loop 630 and the Class A output stage 610 may be configured to set DC current bias in the Class A output stage 610. The output stage bias loop 634 is separate from the preamplifier loop 630 and operates to set the DC current bias in the class A output stage 610 through the OS_BIAS path, enabling very good control on the DC current through the output stage 610.

The two stages of the two-stage amplifier gain loop 608 comprise the Class A output stage 610 and the preamplifier loop 630. The Class A output stage 610 is configured with separate DC bias and AC signal paths for output bias control. The preamplifier loop 630 is configured with an AC-coupled output terminal. A programmable loop compensation technique may be implemented to manage a large variety of output load conditions. Because the common mode suppression circuit 602 is designed for usage with various Ethernet PHY components, the capacitive loading at the output to the Ethernet PHY is not under control of the common mode suppression circuit design. The Ethernet PHY capacitive loading may be very small or highly capacitive, for example a range from 5 pF to 25 pF or even larger ranges. Thus, the common mode suppression circuit 602 may be configured with a variable compensation loop that assists operation across a wide range of frequencies and output loading.

Loop compensation capacitors 626 may be coupled to the Class A output stage 610 reduce loading at the transmit and receive data (TRD+/−) nodes. In another configuration, the compensation capacitors may be connected directly to the output nodes TRD+/−. Connecting the loop compensation capacitors 626 at the NCP-NCN node as depicted may be desirable to avoid increasing loading on the Ethernet PHY 606, enabling a low capacitance design at the cost of a simple change in load size.

The output stage 610 may be configured to roll-off at frequency bands at which the preamplifier loop 630 remains at high gain.

Low differential capacitance at the output of the common mode suppression circuit 602 is implemented to avoid degrading of Ethernet signaling performance as well as to maintain good return loss performance.

The output stage 610 may be configured with a selected Unity Gain Bandwidth (UGBW) and the preamplifier loop configured with a UGBW at approximately four times the output stage UGBW whereby the output stage output signal rolls-off at frequency bands at which the preamplifier loop remains at high gain. In the illustrative example, the common mode suppression circuit 602 is terminated with a common mode impedance R_{T}, for example 50Ω, with Ethernet line termination and approximately 20 pF of capacitive load, setting the primary pole for the loop at 160 MHz. The common mode suppression circuit design enables a compensation technique to cause the output stage to roll-off faster than the preamplifier stage even in presence of Miller compensation in which a capacitor added across an inverting amplifier appears much larger from the input of the amplifier. The compensation technique maintains sufficient common mode noise suppression performance at 100 MHz frequency. The common mode suppression circuit design enables the output stage to roll-off while the input stage remains at high gain.

In some embodiments, the common mode suppression circuit 602 may further comprise an output stage gate reference node (OS_GATE) coupled to the Class A output stage 610 that is configured to be software programmable to accommodate very large signal swings to a V_{CC} range in 10Base-T to 1000Base-T designs with variable output DC control. In an illustrative embodiment, the output DC control is set by an inductor L_{S} or the Ethernet PHY V_{CC}. The output node can have a large signal swing, for example in a range of approximately 0.85V to 5.0V. Therefore the output stage 610 is designed to tolerate such signal swings.

The low frequency bias loop 618 may be configured to set both input and output common mode voltage of the preamplifier loop 630 whereby input common mode control is set by a sum of preamplifier gain and low frequency bias loop gain and output common mode control is set by low frequency bias loop gain.

Biasing for the overall system may be designed to enable excellent noise rejection from the power supply paths. For example referring to FIG. 5, noise may be passing through the power supply Vcc path 530 and through inductors L_{S}, for example 220 uH, and the integrated circuit chip for the interface may also generate a system power supply Vcc. Accordingly, the common mode suppression circuit 502 may be designed with very good power supply rejection capability to prevent passing power supply noise to the output stage. Thus biasing of the overall system is designed to enable excellent noise rejection from the power supply as well as other noise sources.

Referring again to FIG. 6, the common mode suppression circuit 602 may be designed to absorb common mode noise from Ethernet signaling pairs TRD+ and TRD−, preventing noise to pass to the signal line from Ethernet equipment, thereby controlling electromagnetic interference (EMI) emissions, as well as preventing noise passing in from the signal line to impact Ethernet equipment (EMI immunity). Thus, the illustrative common mode suppression circuit 602 can be designed for EMI emission control to avoid passing noise generated in the interface and the Ethernet PHY 606 to pass out to the signal line, and for EMI immunity to prevent noise on the signal line from passing to the interface and Ethernet PHY 606.

The illustrative common mode suppression circuit 602 may be configured to operate by passing signals from a relatively high voltage technology at a network connector to a relatively low voltage technology at an Ethernet physical layer (PHY) module 606. The common mode suppression circuit 602 forms a low impedance pathway from an output terminal of the PHY module 606 to ground that absorbs a common mode noise portion of the signals while enabling a differential portion of the signals to pass. The common mode suppression circuit 602 also suppresses common mode noise using a two-stage amplifier gain loop 608.

The common mode suppression circuit 602 may further be designed to apply a second order roll-off in a range from approximately 10 kHz to 100 kHz and suppress common mode noise by at least 40 dB in a range from approximately 100 kHz to 30 MHz and by at least 30 dB in a range from approximately 30 MHz to 100 MHz.

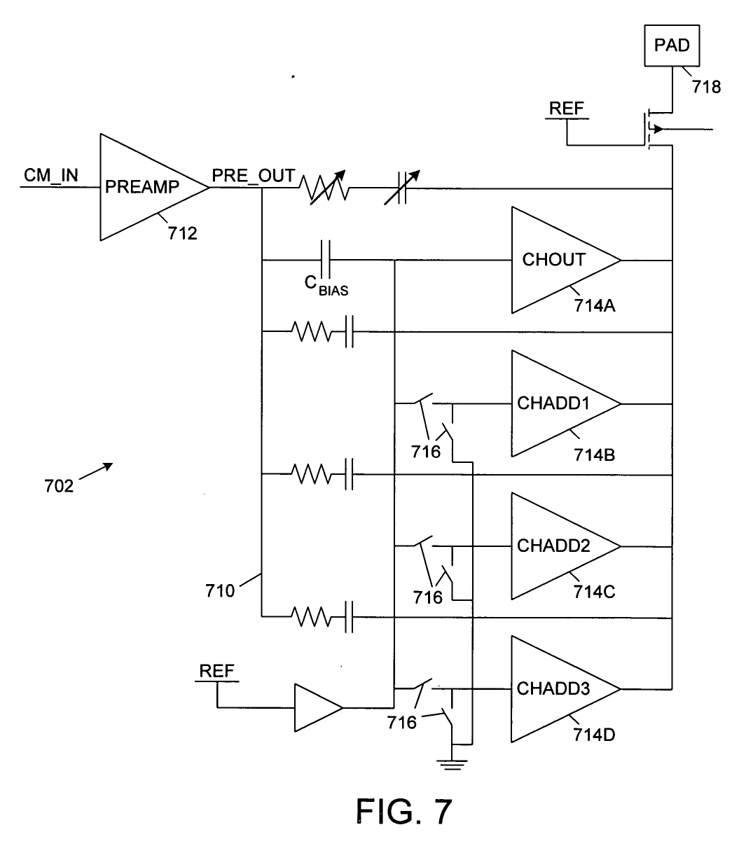

Referring to FIG. 7, a schematic block and circuit diagram illustrates an embodiment of a common mode suppression circuit 702 including a programmable output stage 710. In an illustrative common mode suppression circuit, the output stage 710 may be software programmable to meet different EM immunity requirements and specifications for different applications. For example, the multiple independent bias nodes in the common mode suppression circuit effectively result in formation of four output stage amplifiers 714A-D that are under software control. Some applications may call for different levels of EMI rejection capability. The four output stage amplifiers 714A-D comprise four segments. The multiple segments enable absorption of more electromagnetic interference (EMI). Different applications of the network device may be configured for different absorption capability. The multiple segments may be individually programmed using programmable switches 716. The four segments are all connected to the transmit and receive lines TRD+/−.

The illustrative common mode suppression circuit 702 has a two-stage architecture with a preamplifier 712 and the Class A output stage 710 that enables a design to be constructed in the same process and voltage as the Ethernet PHY, for example 3.3V or 2.5V.

The illustrative preamplifier 712 may be completely AC-coupled. The output common mode can vary largely based on the choice of inductive termination. Accordingly, common mode noise can be reduced by AC coupling the input stage formed by the preamplifier 712. The class A driver has separate DC and AC paths for output bias control. Accordingly, the preamplifier output is also AC coupled. A separate DC feedback loop is connected around the preamplifier 712 that conflicts with the AC common-mode rejection loop.

The illustrative output stage 710 may be constructed with three blocks including a choke output block (CHOUT) 714A, a plurality of choke adder blocks (CHADDn) 714B-D, and a choke pad block (PAD) 718. The output stage 710 may be implemented with a wide output swing specification at a final output node, for example between 0.85V and 2.5V.

The current control capability of the output stage 710 may be implemented to source and sink large common mode noise currents according to various EMI immunity testing standards. In an illustrative embodiment, the output stage can be designed for current in a range from 12 mA to 30 mA in a programmable range of 12/18/24/30 mA. A default may be implemented as 12 mA per node. The output device is a fixed electrostatic discharge (ESD) device. Additional amplifiers 714A-D are summed into the source node.

Stability of the output stage 710 can be implemented with Miller compensation in the input device. Class A stage gain drops as common mode load impedance becomes resistive 252. The preamplifier 712 maintains a wide bandwidth and supplies high frequency gain.

The illustrative common mode suppression circuit enables tuning of the circuit for both low frequency and high frequency performance under various external impedance/resonance constraints. The common mode suppression circuit facilitates replacement of a transformer with transformer equivalent specification.

The IEEE 802.3 Ethernet Standard, which is incorporated herein by reference, addresses loop powering of remote Ethernet devices (802.3af). Power over Ethernet (PoE) standard and other similar standards support standardization of power delivery over Ethernet network cables to power remote client devices through the network connection. The side of link that supplies power is called Powered Supply Equipment (PSE). The side of link that receives power is the Powered device (PD). Other implementations may supply power to network attached devices over alternative networks such as, for example, Home Phoneline Networking alliance (HomePNA) local area networks and other similar networks. HomePNA uses existing telephone wires to share a single network connection within a home or building. In other examples, devices may support communication of network data signals over power lines.

In various configurations described herein, a magnetic transformer of conventional systems may be eliminated while transformer functionality is maintained. Techniques enabling replacement of the transformer may be implemented in the form of integrated circuits (ICs) or discrete components.

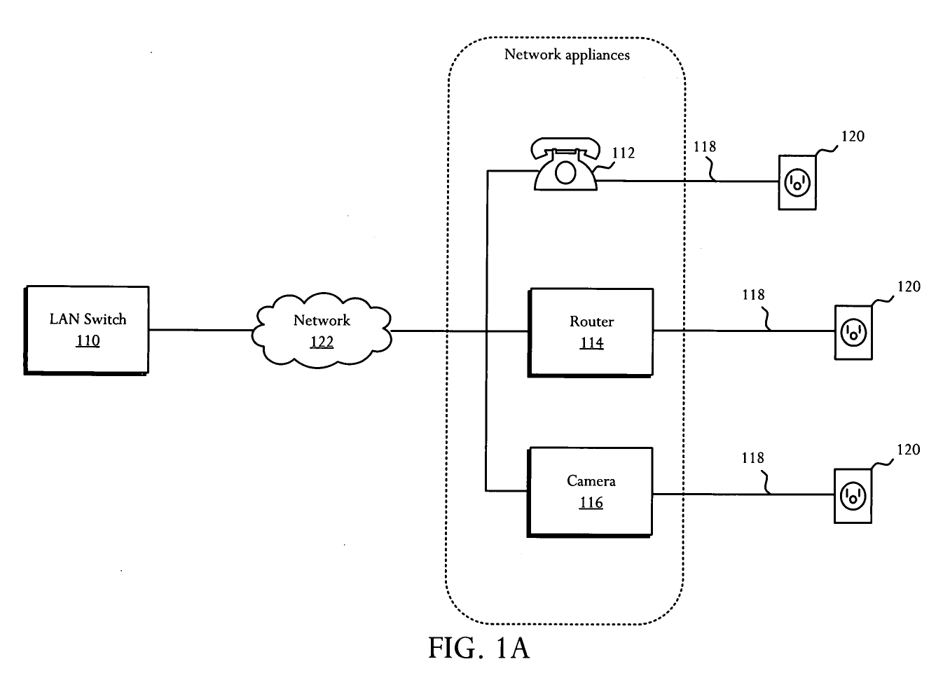

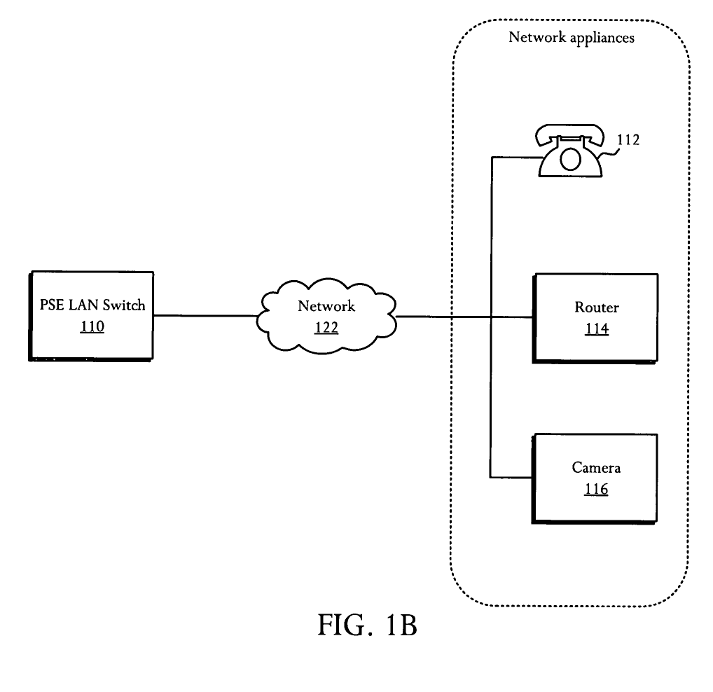

FIG. 1A is a schematic block diagram that illustrates a high level example embodiment of devices in which power is supplied separately to network attached client devices 112 through 116 that may benefit from receiving power and data via the network connection. The devices are serviced by a local area network (LAN) switch 110 for data. Individual client devices 112 through 116 have separate power connections 118 to electrical outlets 120. FIG. 1B is a schematic block diagram that depicts a high level example embodiment of devices wherein a switch 110 is a power supply equipment (PSE)-capable power-over Ethernet (PoE) enabled LAN switch that supplies both data and power signals to client devices 112 through 116. Network attached devices may include a Voice Over Internet Protocol (VOIP) telephone 112, access points, routers, gateways 114 and/or security cameras 116, as well as other known network appliances. Network supplied power enables client devices 112 through 116 to eliminate power connections 118 to electrical outlets 120 as shown in FIG. 1A. Eliminating the second connection enables the network attached device to have greater reliability when attached to the network with reduced cost and facilitated deployment.

Although the description herein may focus and describe a system and method for coupling high bandwidth data signals and power distribution between the integrated circuit and cable that uses transformer-less ICs with particular detail to the IEEE 802.3af Ethernet standard, the concepts may be applied in non-Ethernet applications and non-IEEE 802.3af applications. Also, the concepts may be applied in subsequent standards that supersede or complement the IEEE 802.3af standard.

Various embodiments of the depicted system may support solid state, and thus non-magnetic, transformer circuits operable to couple high bandwidth data signals and power signals with new mixed-signal IC technology, enabling elimination of cumbersome, real-estate intensive magnetic-based transformers.

Typical conventional communication systems use transformers to perform common mode signal blocking, 1500 volt isolation, and AC coupling of a differential signature as well as residual lightning or electromagnetic shock protection. The functions are replaced by a solid state or other similar circuits in accordance with embodiments of circuits and systems described herein whereby the circuit may couple directly to the line and provide high differential impedance and low common mode impedance. High differential impedance enables separation of the physical layer (PHY) signal from the power signal. Low common mode impedance enables elimination of a choke, allowing power to be tapped from the line. The local ground plane may float to eliminate a requirement for 1500 volt isolation. Additionally, through a combination of circuit techniques and lightning protection circuitry, voltage spike or lightning protection can be supplied to the network attached device, eliminating another function performed by transformers in traditional systems or arrangements. The disclosed technology may be applied anywhere transformers are used and is not limited to Ethernet applications.

Specific embodiments of the circuits and systems disclosed herein may be applied to various powered network attached devices or Ethernet network appliances. Such appliances include, but are not limited to VoIP telephones, routers, printers, and other similar devices.

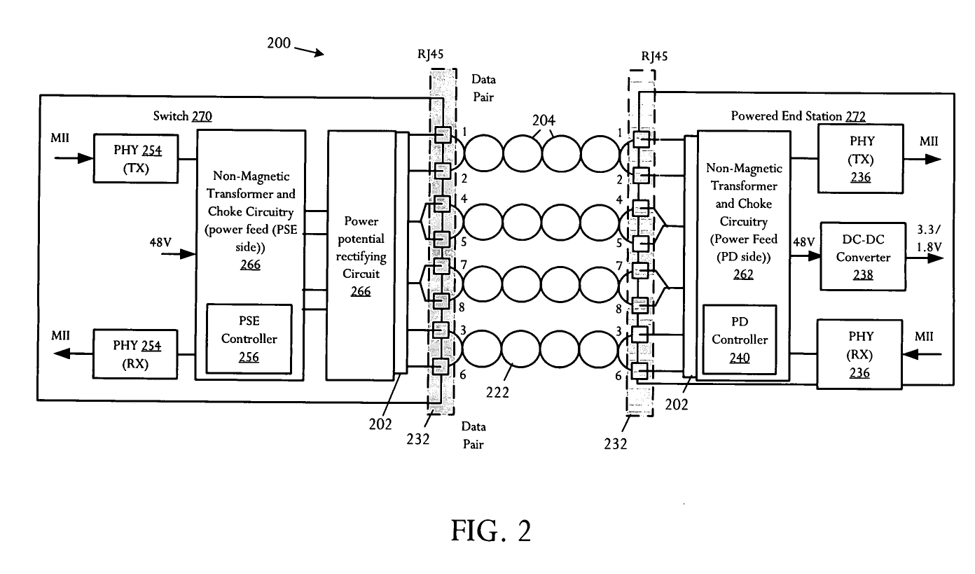

Referring to FIG. 2, a functional block diagram depicts an embodiment of a network device 200 including to power potential rectification. The illustrative network device comprises a power potential rectifier 202 adapted to conductively couple a network connector 232 to an integrated circuit 270, 272 that rectifies and passes a power signal and data signal received from the network connector 232. The power potential rectifier 202 regulates a received power and/or data signal to ensure proper signal polarity is applied to the integrated circuit 270, 272.

The network device 200 is shown with the power sourcing switch 270 sourcing power through lines 1 and 2 of the network connector 232 in combination with lines 3 and 6.

In some embodiments, the power potential rectifier 202 is configured to couple directly to lines of the network connector 232 and regulate the power signal whereby the power potential rectifier 202 passes the data signal with substantially no degradation.

In some configuration embodiments, the network connector 232 receives multiple twisted pair conductors 204, for example twisted 22-26 gauge wire. Any one of a subset of the twisted pair conductors 204 can forward bias to deliver current and the power potential rectifier 202 can forward bias a return current path via a remaining conductor of the subset.

FIG. 2 illustrates the network interface 200 including a network powered device (PD) interface and a network power supply equipment (PSE) interface, each implementing a non-magnetic transformer and choke circuitry. A powered end station 272 is a network interface that includes a network connector 232, non-magnetic transformer and choke power feed circuitry 262, a network physical layer 236, and a power converter 238. Functionality of a magnetic transformer is replaced by circuitry 262. In the context of an Ethernet network interface, network connector 232 may be a RJ45 connector that is operable to receive multiple twisted wire pairs. Protection and conditioning circuitry may be located between network connector 232 and non-magnetic transformer and choke power feed circuitry 262 to attain surge protection in the form of voltage spike protection, lighting protection, external shock protection or other similar active functions. Conditioning circuitry may be a diode bridge or other rectifying component or device. A bridge or rectifier may couple to individual conductive lines 1-8 contained within the RJ45 connector. The circuits may be discrete components or an integrated circuit within non-magnetic transformer and choke power feed circuitry 262.

In an Ethernet application, the IEEE 802.3af standard (PoE standard) enables delivery of power over Ethernet cables to remotely power devices. The portion of the connection that receives the power may be referred to as the powered device (PD). The side of the link that supplies power is called the power sourcing equipment (PSE).

In the powered end station 272, conductors 1 through 8 of the network connector 232 couple to non-magnetic transformer and choke power feed circuitry 262. Non-magnetic transformer and choke power feed circuitry 262 may use the power feed circuit and separate the data signal portion from the power signal portion. The data signal portion may then be passed to the network physical layer (PHY) 236 while the power signal passes to power converter 238.

If the powered end station 272 is used to couple the network attached device or PD to an Ethernet network, network physical layer 236 may be operable to implement the 10 Mbps, 100 Mbps, and/or 1 Gbps physical layer functions as well as other Ethernet data protocols that may arise. The Ethernet PHY 236 may additionally couple to an Ethernet media access controller (MAC). The Ethernet PHY 236 and Ethernet MAC when coupled are operable to implement the hardware layers of an Ethernet protocol stack. The architecture may also be applied to other networks. If a power signal is not received but a traditional, non-power Ethernet signal is received the nonmagnetic power feed circuitry 262 still passes the data signal to the network PHY.

The power signal separated from the network signal within non-magnetic transformer and choke power feed circuit 262 by the power feed circuit is supplied to power converter 238. Typically the power signal received does not exceed 57 volts SELV (Safety Extra Low Voltage). Typical voltage in an Ethernet application is 48-volt power. Power converter 238 may then further transform the power as a DC to DC converter to provide 1.8 to 3.3 volts, or other voltages specified by many Ethernet network attached devices.

Power-sourcing switch 270 includes a network connector 232, Ethernet or network physical layer 254, PSE controller 256, non-magnetic transformer and choke power supply circuitry 266, and possibly a multiple-port switch. Transformer functionality is supplied by non-magnetic transformer and choke power supply circuitry 266. Power-sourcing switch 270 may be used to supply power to network attached devices. Powered end station 272 and power sourcing switch 270 may be applied to an Ethernet application or other network-based applications such as, but not limited to, a vehicle-based network such as those found in an automobile, aircraft, mass transit system, or other like vehicle. Examples of specific vehicle-based networks may include a local interconnect network (LIN), a controller area network (CAN), or a flex ray network. All may be applied specifically to automotive networks for the distribution of power and data within the automobile to various monitoring circuits or for the distribution and powering of entertainment devices, such as entertainment systems, video and audio entertainment systems often found in today's vehicles. Other networks may include a high speed data network, low speed data network, time-triggered communication on CAN (TTCAN) network, a J1939-compliant network, ISO11898-compliant network, an ISO11519-2-compliant network, as well as other similar networks. Other embodiments may supply power to network attached devices over alternative networks such as but not limited to a HomePNA local area network and other similar networks. HomePNA uses existing telephone wires to share a single network connection within a home or building. Alternatively, embodiments may be applied where network data signals are provided over power lines.

Non-magnetic transformer and choke power feed circuitry 262 and 266 enable elimination of magnetic transformers with integrated system solutions that enable an increase in system density by replacing magnetic transformers with solid state power feed circuitry in the form of an integrated circuit or discreet component.

In some embodiments, non-magnetic transformer and choke power feed circuitry 262, network physical layer 236, power distribution management circuitry 254, and power converter 238 may be integrated into a single integrated circuit rather than discrete components at the printed circuit board level. Optional protection and power conditioning circuitry may be used to interface the integrated circuit to the network connector 232.

The Ethernet PHY may support the 10/100/1000 Mbps data rate and other future data networks such as a 10000 Mbps Ethernet network. Non-magnetic transformer and choke power feed circuitry 262 supplies line power minus the insertion loss directly to power converter 238, converting power first to a 12V supply then subsequently to lower supply levels. The circuit may be implemented in any appropriate process, for example a 0.18 or 0.13 micron process or any suitable size process.

Non-magnetic transformer and choke power feed circuitry 262 may implement functions including IEEE 802.3.af signaling and load compliance, local unregulated supply generation with surge current protection, and signal transfer between the line and integrated Ethernet PHY. Since devices are directly connected to the line, the circuit may be implemented to withstand a secondary lightning surge.

For the power over Ethernet (PoE) to be IEEE 802.3af standard compliant, the PoE may be configured to accept power with various power feeding schemes and handle power polarity reversal. A rectifier, such as a diode bridge, a switching network, or other circuit, may be implemented to ensure power signals having an appropriate polarity are delivered to nodes of the power feed circuit. Any one of the conductors 1, 4, 7 or 3 of the network RJ45 connection can forward bias to deliver current and any one of the return diodes connected can forward bias to form a return current path via one of the remaining conductors. Conductors 2, 5, 8 and 4 are connected similarly.

Non-magnetic transformer and choke power feed circuitry 262 applied to PSE may take the form of a single or multiple port switch to supply power to single or multiple devices attached to the network. Power sourcing switch 270 may be operable to receive power and data signals and combine to communicate power signals which are then distributed via an attached network. If power sourcing switch 270 is a gateway or router, a high-speed uplink couples to a network such as an Ethernet network or other network. The data signal is relayed via network PHY 254 and supplied to non-magnetic transformer and choke power feed circuitry 266. PSE switch 270 may be attached to an AC power supply or other internal or external power supply to supply a power signal to be distributed to network-attached devices that couple to power sourcing switch 270. Power controller 256 within or coupled to non-magnetic transformer and choke power feed circuitry 266 may determine, in accordance with IEEE standard 802.3af, whether a network-attached device in the case of an Ethernet network-attached device is a device operable to receive power from power supply equipment. When determined that an IEEE 802.3af compliant powered device (PD) is attached to the network, power controller 256 may supply power from power supply to non-magnetic transformer and choke power feed circuitry 266, which is sent to the downstream network-attached device through network connectors, which in the case of the Ethernet network may be an RJ45 receptacle and cable.

IEEE 802.3af Standard is to fully comply with existing non-line powered Ethernet network systems. Accordingly, PSE detects via a well-defined procedure whether the far end is PoE compliant and classify sufficient power prior to applying power to the system. Maximum allowed voltage is 57 volts for compliance with SELV (Safety Extra Low Voltage) limits.

For backward compatibility with non-powered systems, applied DC voltage begins at a very low voltage and only begins to deliver power after confirmation that a PoE device is present. In the classification phase, the PSE applies a voltage between 14.5V and 20.5V, measures the current and determines the power class of the device. In one embodiment the current signature is applied for voltages above 12.5V and below 23 Volts. Current signature range is 0-44 mA.

The normal powering mode is switched on when the PSE voltage crosses 42 Volts where power MOSFETs are enabled and the large bypass capacitor begins to charge.

A maintain power signature is applied in the PoE signature block—a minimum of 10 mA and a maximum of 23.5 kohms may be applied for the PSE to continue to feed power. The maximum current allowed is limited by the power class of the device (class 0-3 are defined). For class 0, 12.95 W is the maximum power dissipation allowed and 400 ma is the maximum peak current. Once activated, the PoE will shut down if the applied voltage falls below 30V and disconnect the power MOSFETs from the line.

Power feed devices in normal power mode provide a differential open circuit at the Ethernet signal frequencies and a differential short at lower frequencies. The common mode circuit presents the capacitive and power management load at frequencies determined by the gate control circuit.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A network device comprising:
an active common mode suppression circuit coupled in parallel to transmit and receive differential signal lines connecting an Ethernet physical layer (PHY) module and a network connector.

2. The network device according to claim 1 further comprising:
the active common mode suppression circuit configured to absorb common mode noise by forming a low impedance path from the PHY module output to a ground.

3. The network device according to claim 1 wherein:
the PHY module has a Class A driver whereby output common mode level of the PHY module can vary up to V_{CC}.

4. The network device according to claim 1 further comprising:
the active common mode suppression circuit configured to terminate common mode impedance over the Ethernet signal frequency range.

5. The network device according to claim 1 further comprising:
the active common mode suppression circuit configured to terminate common mode impedance over an Ethernet signal frequency range whereby the active common mode suppression circuit forms a loop that creates a second-order roll-off in common mode noise suppression at frequencies above 10 kHz.

6. The network device according to claim 1 further comprising:
the active common mode suppression circuit configured in a Class A architecture that matches Ethernet PHY line drivers whereby the Ethernet PHY controls output line signal common mode direct current (DC) voltage.

7. The network device according to claim 1 further comprising:
the active common mode suppression circuit and the Ethernet PHY formed in a same fabrication process and voltage.

8. The network device according to claim 1 further comprising:
the active common mode suppression circuit comprises a two-stage amplifier gain loop whereby common mode noise is suppressed by at least 40 dB from 100 kHz to 30 MHz.

9. The network device according to claim 1 further comprising:
the active common mode suppression circuit comprises a Class A output stage coupled between the Ethernet PHY and a first stage preamplifier, the first stage preamplifier and the Class A output stage forming a two-stage amplifier gain loop, the first stage preamplifier being capacitively-coupled at input and output terminals.

10. The network device according to claim 1 further comprising:
the active common mode suppression circuit comprises a Class A output stage coupled between the Ethernet PHY and a first stage preamplifier, the first stage preamplifier and the Class A output stage forming a two-stage amplifier gain loop, the first stage preamplifier forming a preamplifier loop with signal and bias controlled at a common input node.

11. The network device according to claim 1 further comprising:
the active common mode suppression circuit comprises a two-stage amplifier gain loop, a preamplifier loop coupled to the two-stage amplifier gain loop, a low frequency bias loop coupled to the preamplifier loop, a DC filter coupled to the low frequency bias loop, and common mode sampling capacitors coupled from an input terminal to the preamplifier loop to transmit and receive data (TRD+/−) lines to the Ethernet PHY, the DC filter and the common mode sampling capacitors being configured to set low frequency bias loop bandwidth.

12. The network device according to claim 11 further comprising:
the active common mode suppression circuit is configured to transition from direct current (DC) control to alternating current (AC) control at a sufficiently low frequency that AC performance begins at approximately 10 kHz.

13. The network device according to claim 11 further comprising:
the DC filter is configured to create resonance in a common mode suppression transfer function in a range approximately between 100 kHz and 30 MHz whereby common mode noise is suppressed by at least approximately 40 dB and conductive emissions are reduced in a band approximately between 100 kHz and 30 MHz.

14. The network device according to claim 11 further comprising:
a Class A output stage coupled between the Ethernet PHY and the preamplifier loop;
a first node coupled to an input terminal to the preamplifier loop and to transmit and receive data (TRD+/−) lines to the Ethernet PHY;
a second node coupled to an output terminal to the preamplifier loop; and
a third node coupled to an input terminal to the Class A output stage, the first, second, and third nodes configured to set DC bias independently.

15. The network device according to claim 11 further comprising:
a Class A output stage coupled between the Ethernet PHY and the preamplifier loop; and
an output stage bias loop coupled between the preamplifier loop and the Class A output stage configured to set DC current bias in the Class A output stage.

16. The network device according to claim 11 further comprising:
a Class A output stage coupled between the Ethernet PHY and the preamplifier loop and configured with separate DC bias and AC signal paths for output bias control; and
the preamplifier loop configured with an AC-coupled output terminal.

17. The network device according to claim 11 further comprising:
a Class A output stage coupled between the Ethernet PHY and the preamplifier loop; and
loop compensation capacitors coupled to the Class A output stage whereby loading is reduced at the transmit and receive data (TRD+/−) lines.

18. The network device according to claim 11 further comprising:
a Class A output stage coupled between the Ethernet PHY and the preamplifier loop, the output stage configured to roll-off at frequency bands that the preamplifier loop remains at high gain.

19. The network device according to claim 11 further comprising:
a Class A output stage coupled between the Ethernet PHY and the preamplifier loop, the output stage configured with a selected Unity Gain Bandwidth (UGBW) and the preamplifier loop configured with a UGBW at approximately four times the output stage UGBW whereby the output stage rolls-off at frequency bands that the preamplifier loop remains at high gain.

20. The network device according to claim 11 further comprising:
a Class A output stage coupled between the Ethernet PHY and the preamplifier loop; and
an output stage gate reference node coupled to the Class A output stage and configured as software programmable to accommodate signal swings to a V_{CC} range in 10Base-T, 100Base-T, and 1000Base-T designs with variable output DC control.

21. The network device according to claim I I further comprising:
the low frequency bias loop configured to set both input and output common mode voltage of the preamplifier loop whereby input common mode control is set by a sum of preamplifier gain and low frequency bias loop gain and output common mode control is set by low frequency bias loop gain.

22. A network device comprising:
an interface coupled in parallel to transmit and receive differential signal lines connecting an Ethernet physical layer (PHY) module and a network connector operative at a voltage substantially higher than the PHY module, the interface comprising a two-stage amplifier gain loop whereby common mode noise is suppressed by at least 40 dB from 100 kHz to 30 MHz, the two-stage amplifier gain loop comprising a Class A output stage coupled between the Ethernet PHY and a first stage preamplifier that is capacitively-coupled at input and output terminals.

23. A network device comprising:
an interface coupled in parallel to transmit and receive differential signal lines connecting an Ethernet physical layer (PHY) module and a network connector operative at a voltage substantially higher than the PHY module, the interface comprising a two-stage amplifier gain loop, a preamplifier loop coupled to the two-stage amplifier gain loop, a low frequency bias loop coupled to the preamplifier loop, a DC filter coupled to the low frequency bias loop, and common mode sampling capacitors coupled from an input terminal to the preamplifier loop to transmit and receive data (TRD+/−) lines to the Ethernet PHY, the DC filter and the common mode sampling capacitors being configured to set low frequency bias bandwidth.

24. A network device comprising:
an interface coupled in parallel to transmit and receive differential signal lines connecting an Ethernet physical layer (PHY) module and a network connector operative at a voltage substantially higher than the PHY module, the interface comprising a preamplifier, a Class A output stage coupled between the Ethernet PHY and the preamplifier, a low frequency bias loop coupled to the preamplifier, and a DC filter coupled to the low frequency bias loop, the preamplifier being capacitively-coupled at input and output terminals.

25. A method of operating a network device comprising:
passing signals from a relatively high voltage technology at a network connector to a relatively low voltage technology at an Ethernet physical layer (PHY) module;
forming a low impedance pathway from an output terminal of the PHY module to ground that absorbs a common mode noise portion of the signals while enabling a differential portion of the signals to pass; and
suppressing common mode noise using a two-stage amplifier gain loop.

26. The method according to claim 25 further comprising:
applying a second order roll-off in a range from approximately 10 kHz to 100 kHz; and
suppressing the common mode noise by at least 40 dB in a range from approximately 100 kHz to 30 MHz and by 30 dB in a range from 30 MHz to 100 MHz.
